(19) United States
(12) Patent Application Publication
(10) Pub. No.: US 2025/0286956 A1
(43) Pub. Date: Sep. 11, 2025

(54) IMAGE FORMING APPARATUS, IMAGE FORMING METHOD, AND STORAGE MEDIUM

(71) Applicant: CANON KABUSHIKI KAISHA, Tokyo (JP)

(72) Inventors: Midori Inaba, Tokyo (JP); Ryota Ichiba, Tokyo (JP)

(21) Appl. No.: 19/063,819

(22) Filed: Feb. 26, 2025

(30) Foreign Application Priority Data
Mar. 5, 2024 (JP) 2024-032790

(51) Int. Cl. H04N 1/00; H04N 1/60

(52) U.S. Cl. CPC H04N 1/00005; H04N 1/6055; H04N 2201/0005

(57) ABSTRACT

An image forming apparatus includes a print unit configured to perform printing, and a control unit configured to cause the print unit to print a chart image in which an identification pattern for identifying a defect in the print unit is formed and a pattern image different from the identification pattern such that the pattern image is overlaid on the chart image.

### BACKGROUND

### Field

The present disclosure relates to a technique for identifying conditions of an image forming apparatus.

### Description of the Related Art

In the field of image forming apparatuses such as copiers, printers, and multifunction apparatuses, there is a known apparatus having an image diagnosis technique for predicting, before image quality deterioration actually occurs, a period until the image quality deterioration occurs by using a scanned image obtained by reading an image formed on a print medium. For example, such an apparatus detects an image quality defect such as a streak or a dot defect in a scanned image obtained by reading a printed product in which a chart image is printed on a paper sheet, at a stage at which such defect is not yet visible to the human eye, and makes a response such as notifying a service of a request for a part replacement in advance.

Japanese Patent Laid-Open No. 2007-116670 describes a technique for manually or periodically diagnosing conditions of an image forming apparatus based on a scanned chart image obtained by scanning a printed product of a chart image printed for image diagnosis.

### SUMMARY

An image forming apparatus according to an embodiment of the present disclosure includes a print unit configured to perform printing, and a control unit configured to cause the print unit to print a chart image in which an identification pattern for identifying a defect in the print unit is formed and a pattern image different from the identification pattern such that the pattern image is overlaid on the chart image.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration example of an image processing apparatus;

FIG. 2 is a block diagram illustrating a functional configuration example of the image processing apparatus;

FIG. 3 is a flowchart presenting a sequence of processes to be executed by the image processing apparatus;

FIG. 4 is a flowchart presenting a detailed sequence of a random noise chart creation process;

FIG. 5 is a flowchart presenting a detailed sequence of an image difference diagnosis process;

FIGS. 6A to 6C are views presenting examples of image data;

FIG. 7 is an explanatory diagram of the image difference diagnosis process;

FIG. 8 is a diagram presenting an example of image diagnosis results;

FIG. 9 is a flowchart presenting a detailed sequence of a response determination process;

FIG. 10 is a diagram presenting an example of results of interest level analysis;

FIG. 11 is a block diagram illustrating a functional configuration example of an image processing apparatus;

FIG. 12 is a flowchart presenting a sequence of processes to be executed by the image processing apparatus;

FIG. 13 is a flowchart presenting a detailed sequence of a defect imitation chart creation process;

FIGS. 14A to 14C are diagrams illustrating examples of defect probability distribution information;

FIGS. 15A to 15C are diagrams illustrating examples of defect imitation data;

FIGS. 16A to 16C are views presenting examples of image data;

FIG. 17 is a diagram presenting an example of interest level analysis results;

FIG. 18 is a block diagram illustrating a functional configuration of an image processing apparatus;

FIG. 19 is a flowchart presenting a sequence of processes to be executed by the image processing apparatus;

FIG. 20 is a flowchart presenting a detailed sequence of a message-overlaid chart creation process; and

FIGS. 21A to 21C are views presenting examples of image data.

### DESCRIPTION OF THE EMBODIMENTS

A chart image for image diagnosis is an image printed with various parameter values set for diagnosis and with controls such as a streak correction control turned off, and therefore sometimes exhibits a defect in an overemphasized manner even though the defect is invisible to the human eye in an actual printed product. As a result, a user viewing a printed product of a chart image may mistakenly identify an image quality deterioration unrelated to a defect in an image forming apparatus as an image quality deterioration due to a defect in the image forming apparatus, which may result in downtime due to a shutdown of the image forming apparatus for inspection or adjustment. The technique of the present disclosure was made in view of the foregoing problem.

Hereinafter, embodiments for carrying out the present disclosure will be described in detail with reference to the drawings. It should be noted that the following embodiments are not intended to limit the present disclosure according to claims. A full combination of multiple features described in each of the following embodiments is not essential to achieve the object of the disclosure, and some of the multiple features may be combined as desired. The same constituent elements will be described with the same reference sign. Each step in the following flowcharts is expressed with “S” added as a prefix.

### First Embodiment

In the present embodiment, description will be given of an image diagnosis method using a random noise chart image.

### (Hardware Configuration of Image Processing System)

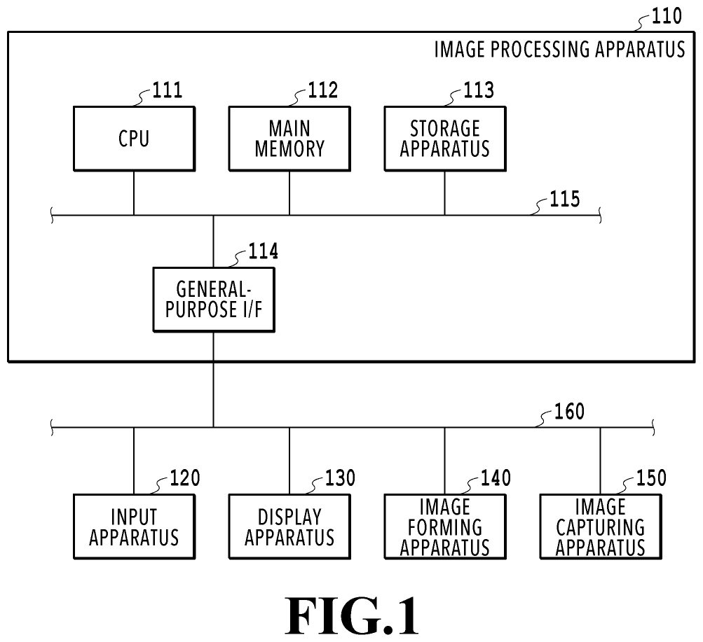

FIG. 1 is a diagram illustrating a hardware configuration of an image processing system according to the present embodiment. The image processing system in the present embodiment executes a series of processes. The image processing system in the present embodiment includes an image processing apparatus 110, an input apparatus 120, a display apparatus 130, an image forming apparatus 140, an image capturing apparatus 150, and a general-purpose bus 160.

The image processing apparatus 110 internally includes a central processing unit (CPU) 111, a main memory 112, a storage apparatus 113, a general-purpose I/F 114, and a bus 115. The CPU 111 executes computation processes and various programs. The main memory 112 provides the CPU 111 with programs, data, and a work area necessary for the processes. The storage apparatus 113 is an apparatus that stores the various programs and data, and is, for example, a hard disk or solid state drive (SSD). The general-purpose I/F 114 is an interface for connecting the image processing apparatus 110 to external apparatuses. As the general-purpose I/F 114, for example, Universal Serial Bus (USB) or High-Definition Multimedia Interface (HDMI (registered trademark)) is used. Instead, as the general-purpose I/F 114, for example, a wired local area network (LAN) or wireless LAN is used. The bus 115 is a bus connecting the components 111 to 114 so that they can transmit and receive data to and from each other.

The input apparatus 120 is an apparatus to be operated by a user for inputs, and is, for example, a keyboard or mouse. The input apparatus 120 is connected to the image processing apparatus 110 via the general-purpose bus 160.

The display apparatus 130 is an apparatus for displaying images, numeric value data, and the like created by the CPU 111, and is, for example, a CRT, a liquid crystal screen, or a head mount display. As in the case of the input apparatus 120, the display apparatus 130 is also connected to the image processing apparatus 110 via the general-purpose bus 160.

The image forming apparatus 140 is an apparatus for printing image data created by the CPU 111, and is, for example, an inkjet printer or an electrophotographic printer, which forms two-dimensional images on media. As in the case of the input apparatus 120, the image forming apparatus 140 is also connected to the image processing apparatus 110 via the general-purpose bus 160.

The image capturing apparatus 150 is an apparatus that obtains a captured image, which is a two-dimensional optical image, by using a sensor and is, for example, a scanner or a camera. As in the case of the input apparatus 120, the image capturing apparatus 150 is also connected to the image processing apparatus 110 via the general-purpose bus 160.

The general-purpose bus 160 is a bus for connecting the foregoing apparatuses to each other. The type of general-purpose bus 160 is changed depending on the type of general-purpose I/F 114. In the case where the general-purpose I/F 114 is of a wired system such as USB, HDMI, or wired LAN, a cable appropriate for that system is used. In the case where the general-purpose I/F 114 is of a wireless system such as wireless LAN, a communication method appropriate for that system is used.

Although the hardware configuration of the image processing system in the present embodiment includes various other constituent elements in addition to those described above, description thereof is omitted herein because they do not act as main elements in the technique of the present disclosure.

### (Functional Configuration of Image Processing System)

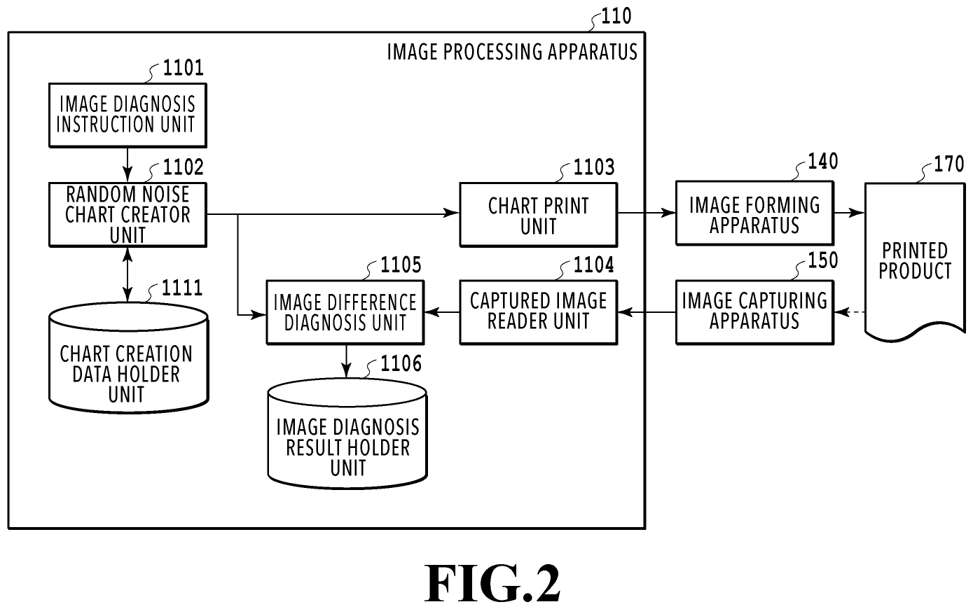

FIG. 2 is a diagram illustrating a functional configuration example of the image processing system in the present embodiment. In the present embodiment, the image processing apparatus 110 has functional units for internally carrying out an image diagnosis. The image forming apparatus 140 has a functional unit for printing and outputting a printed product 170. The image capturing apparatus 150 has a functional unit for capturing an image of the printed product 170.

The image processing apparatus 110 has, as the functional units for carrying out an image diagnosis, an image diagnosis instruction unit 1101, a random noise chart creator unit 1102, a chart print unit 1103, a captured image reader unit 1104, an image difference diagnosis unit 1105, and an image diagnosis result holder unit 1106. The image processing apparatus 110 further includes a chart creation data holder unit 1111.

The image diagnosis instruction unit 1101 issues an instruction to perform an image diagnosis. In response to the instruction to perform the image diagnosis, the random noise chart creator unit (hereinafter referred to as a first chart creator unit) 1102 creates a random noise chart for image diagnosis. The random noise chart for image diagnosis will be described later in detail.

The chart print unit 1103 performs control to cause the image forming apparatus 140 to print the random noise chart by transmitting the random noise chart to the image forming apparatus 140.

In response to reception of the random noise chart, the image forming apparatus 140 executes image processing for printing such as color conversion and halftoning on the random noise chart, and then forms the printed product 170 by using an image forming method.

The image capturing apparatus 150 captures an image of the printed product 170 by using an image capturing method, and thereby obtains the captured image of the printed product 170.

The captured image reader unit 1104 reads the captured image.

The image difference diagnosis unit 1105 analyzes a difference between the random noise chart and the captured image, and diagnoses the conditions of the image forming apparatus 140 based on the obtained analysis result. The diagnosis process will be described later in detail. The image difference diagnosis unit 1105 writes the obtained diagnosis result to the image diagnosis result holder unit 1106. The image difference diagnosis unit 1105 also determines a response based on the diagnosis result. The response determination process will be described later in detail.

The image diagnosis result holder unit 1106 holds the diagnosis result obtained in the diagnosis by the image difference diagnosis unit 1105.

The chart creation data holder unit 1111 holds data for chart creation such, for example, as chart parameters to be used in the random noise chart creator unit 1102.

### (Processes to be Executed by Image Processing System)

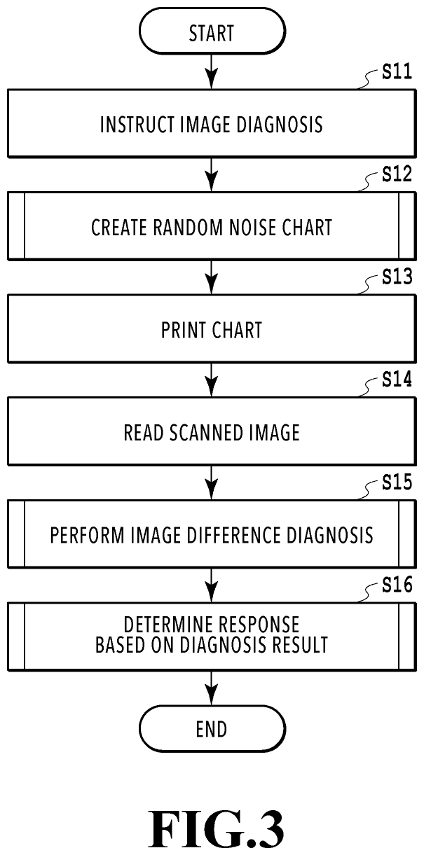

FIG. 3 is a flowchart presenting a sequence of processes to be executed by the image processing system in the present embodiment. In the present embodiment, it is assumed that the image forming apparatus 140 is an electrophotographic digital printer, and the image capturing apparatus 150 is a scanner capable of performing scanning on a paper sheet under feeding continuous from the digital printer.

In S11, the image diagnosis instruction unit 1101 issues an instruction to perform an image diagnosis. In the present embodiment, the image diagnosis is performed at predetermined intervals while the image forming apparatus 140 is executing print jobs. Specifically, an instruction to perform an image diagnosis is issued every time the count for the printed products exceeds 1000 pages.

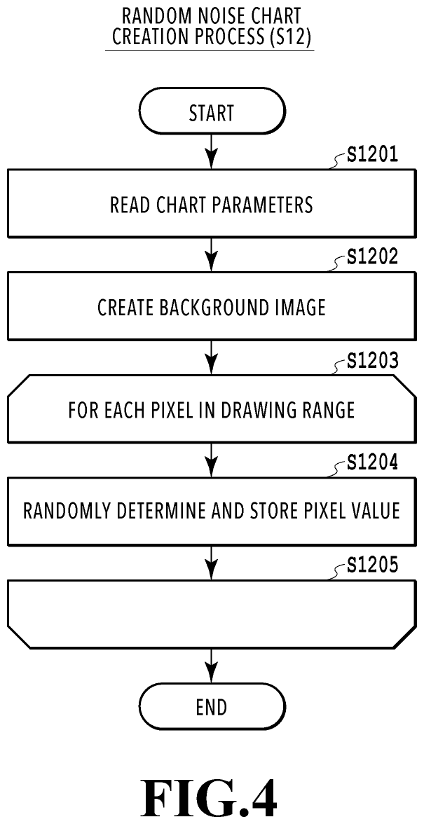

In S12, the first chart creator unit 1102 creates a random chart image, which is one of types of chart images. The random chart image creation process will be described in detail by using FIG. 4.

### (Random Noise Chart Creation Process)

FIG. 4 is a flowchart presenting a detailed sequence of the random noise chart creation process (S12).

In S1201, the first chart creator unit 1102 reads the chart parameters held in advance in the chart creation data holder unit 1111. The chart parameters include an image size, a resolution, and color information. In the present embodiment, the image size is A3 sheet size, the resolution is 150 dpi, and the image format is 8-bit grayscale.

In S1202, the first chart creator unit 1102 creates a background image. The background image is created based on the above chart parameters. In all the pixel values of the background image, 255 (white) is stored.

In S1203, the first chart creator unit 1102 starts an iteration process on all the pixels in a drawing range of the background image. In the present embodiment, an area inside a 10 mm-margin of the sheet size, which is a printable area of the image forming apparatus 140, is set as the drawing range.

In S1204, for a pixel of interest, the first chart creator unit 1102 randomly determines and stores a pixel value. In the present embodiment, since the background image is a 8-bit grayscale image, a pixel value within the range of 0 to 255 is randomly determined at an equal probability. The determined pixel value is stored in the pixel of interest.

In S1205, the first chart creator unit 1102 determines whether or not the process is completed on all the pixels in the drawing range. In a case where it is determined that the process is not completed, the process is returned to S1203. In a case where it is determined that the process is completed, the sequence presented in FIG. 4 is ended. In other words, the creation of an image randomly provided with noise is ended.

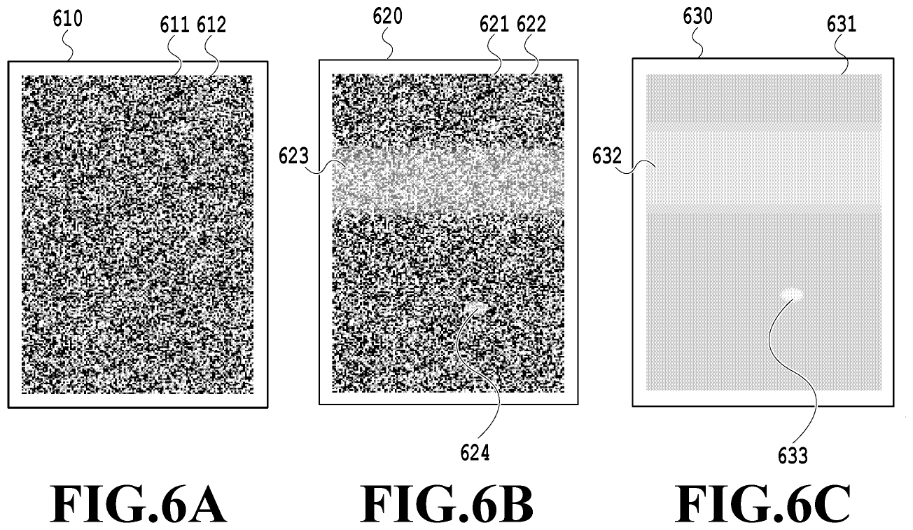

FIG. 6A presents an example of a random chart image created in S12. Here, a random chart image 610 contains a chart image 611 in which an identification pattern for identifying defects in the image forming apparatus 140 is formed, and a random noise chart 612 which is a visibility reducing pattern image for making the above identification pattern less visible.

The description returns to FIG. 3. In S13, the chart print unit 1103 causes execution of printing of the random chart image created in S12. In the present embodiment, the chart print unit 1103 transmits the data of the random chart image to the image forming apparatus 140 and instructs the image forming apparatus 140 to print it. In response to the reception of the random chart image, the image forming apparatus 140 executes the image processing for printing such as color conversion and halftoning and then forms the printed product 170. The image processing for printing is not a main point of the present embodiment, and detailed description thereof is omitted herein.

In S14, the captured image reader unit 1104 reads a captured image. In this step, the captured image reader unit 1104 reads a scanned image obtained by scanning the printed product 170 with the image capturing apparatus 150. The scanned image has an image size of A3 sheet size, a resolution of 300 dpi, and color information of 24-bit RGB. FIG. 6B presents an example of the scanned image read in S14. A scanned image 620 contains a chart image 621 in which identification patterns 623 and 624 for identifying defects in the image forming apparatus 140 are formed. In addition, the scanned image 620 contains a random noise chart 622 that is a visibility reducing pattern image for making the identification patterns 623 and 624 less visible.

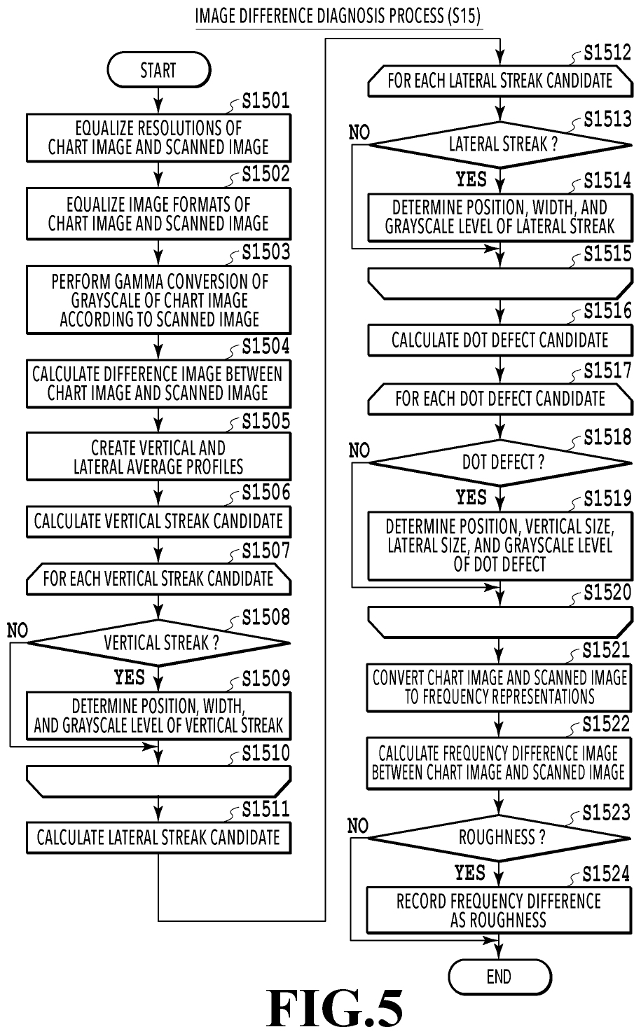

In S15, the image difference diagnosis unit 1105 executes an image difference diagnosis process. The image difference diagnosis process will be described in detail by using FIG. 5.

### (Image Difference Diagnosis Process)

FIG. 5 is a flowchart presenting a detailed sequence of the image difference diagnosis process (S15).

In S1501, the image difference diagnosis unit 1105 performs a process of equalizing the resolutions of the chart image and the scanned image as a preparatory process of difference analysis. In the present embodiment, the resolution of the chart image is 150 dpi, whereas the resolution of the scanned image is 300 dpi. In order to equalize the resolutions of these two images to 300 dpi, the resolution of the chart image is converted. The resolution is converted by using a nearest neighbor method, which is generally used to enlarge an image.

In S1502, the image difference diagnosis unit 1105 performs a process of equalizing the image formats of the chart image and the scanned image as a preparatory process of difference analysis. In the present embodiment, the image format of the chart image is 8-bit grayscale, whereas the image formation of the scanned image is 24-bit RGB. In order to equalize the image formats of these two images to 8-bit grayscale, the scanned image is converted into the 8-bit grayscale image by averaging the RGB pixel values of the scanned image.

In S1503, the image difference diagnosis unit 1105 performs gamma conversion of the grayscale of the chart image in accordance with the scanned image as a preparatory process of difference analysis. As a grayscale gamma LUT for use in the conversion, data held in advance in the chart creation data holder unit 1111 is used. Thus, the grayscale of the chart image after the gamma conversion is equalized to the grayscale of the scanned image.

In S1504, the image difference diagnosis unit 1105 calculates a difference image between the chart image created in S12 and the scanned image read in S14. A difference image D (x, y) is calculated in accordance with the following equation, where C (x,y) denotes the chart image and S (x, y) denotes the scanned image:

$$D ( x , y ) = S ( x , y ) - C ( x , y ) + 128.$$

In the above equation, x denotes an index indicating a position of each pixel in an x direction, and y denotes an index indicating a position of each pixel in a y direction. The reason for adding 128 is to offset the obtained difference to 128, which is a median value of 8 bits, because the difference alone may take a minus value.

FIGS. 6A to 6C present the images described in the steps S1501 to S1504. Specifically, FIG. 6A presents the example of the chart image, FIG. 6B presents the example of the scanned image, and FIG. 6C presents an example of a difference image. A difference image 630 contains a chart image 631 in which identification patterns 632 and 633 for identifying defects in the image forming apparatus 140 are formed.

In S1505, the image difference diagnosis unit 1105 creates a vertical average profile and a lateral average profile of the difference image. The vertical average profile is obtained by averaging the pixel values of the difference image in the y direction. Similarly, the lateral average profile is obtained by averaging the pixel values of the difference image in the x direction.

### (Average Profiles of Difference Image)

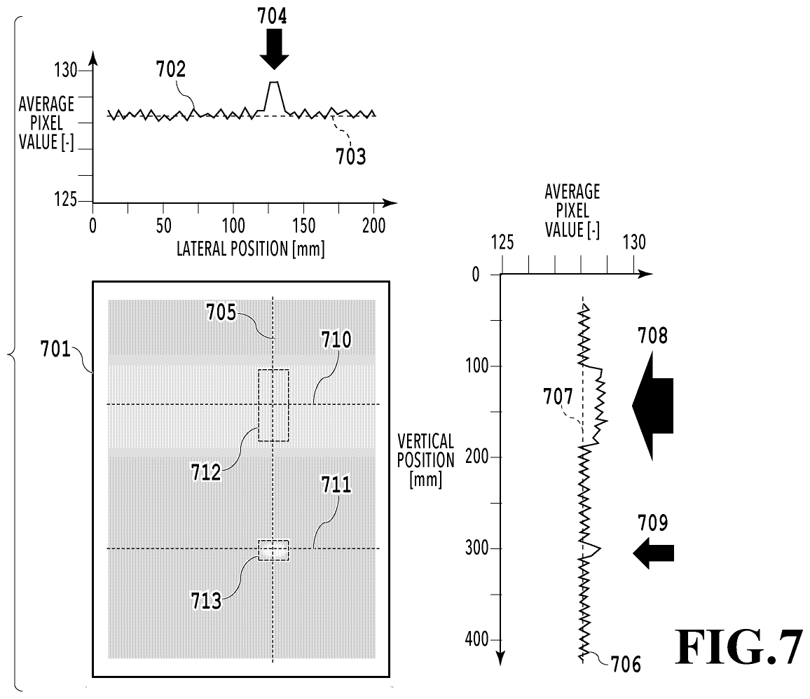

FIG. 7 includes schematic diagrams presenting an example of average profiles of a difference image. A profile 702 represents a vertical average profile of a difference image 701. A broken line 703 indicates an average value of the vertical profile 702. A profile 706 represents a lateral average profile of the difference image 701. A broken line 707 indicates an average value of the lateral profile 706.

In steps S1506 to S1510, a determination about a vertical streak (vertical streak defect) is made. First, in S1506, the image difference diagnosis unit 1105 extracts vertical streak candidates. A portion at which the value of the vertical average profile increases or decreases from the average value of the vertical average profile by a previously-specified threshold or more is determined as a vertical streak candidate. In the case of the example in FIG. 7, a lateral position 704 at which the value of the vertical profile 702 changes by a previously-specified threshold of +1 or more from the average value 703 of the vertical profile 702 is extracted as a vertical streak candidate. In the case where successive lateral positions are extracted as vertical streak candidates, the successive lateral positions are extracted as one streak candidate having a certain width in the lateral direction.

In S1507, the image difference diagnosis unit 1105 starts an iteration process on each of vertical streak candidates. In the case of the example in FIG. 7, there is only vertical streak candidate at the lateral position 704 and accordingly the iteration process is executed only once.

In S1508, the image difference diagnosis unit 1105 determines whether or not the vertical streak candidate is a vertical streak. The determination method includes checking the vertical average profile at the lateral position of the vertical streak candidate, and determining the vertical streak candidate as a vertical streak in a case where the variance of the pixel values is less than a previously-specified threshold. In the case of the example in FIG. 7, the vertical average profile at the lateral position 704 of the vertical streak candidate is of a profile along a broken line 705 of the difference image 701. Since the variance value of the profile along the broken line 705 exceeds a previously-specified threshold of 1, it is determined that the vertical streak candidate is not a vertical streak. The process proceeds to S1510 in a case where it is determined that the vertical streak candidate is not a vertical streak (NO in S1508). The process proceeds to S1509 in a case where it is determined that the vertical streak candidate is a vertical streak (YES in S1508).

The image difference diagnosis unit 1105 performs a process in S1509 in a case where it is determined in S1508 that the vertical streak candidate is a vertical streak. The image difference diagnosis unit 1105 determines the lateral position, the width, and the grayscale level of the vertical streak, thereby obtaining an image diagnosis result. Then, the obtained image diagnosis result is stored. In the present embodiment, the lateral position and the width are vertical streak information converted in the units of mm, and the grayscale level is a luminance value to which the pixel value is converted. The conversion to the luminance value uses a conversion LUT prepared in advance.

### (Image Diagnosis Results)

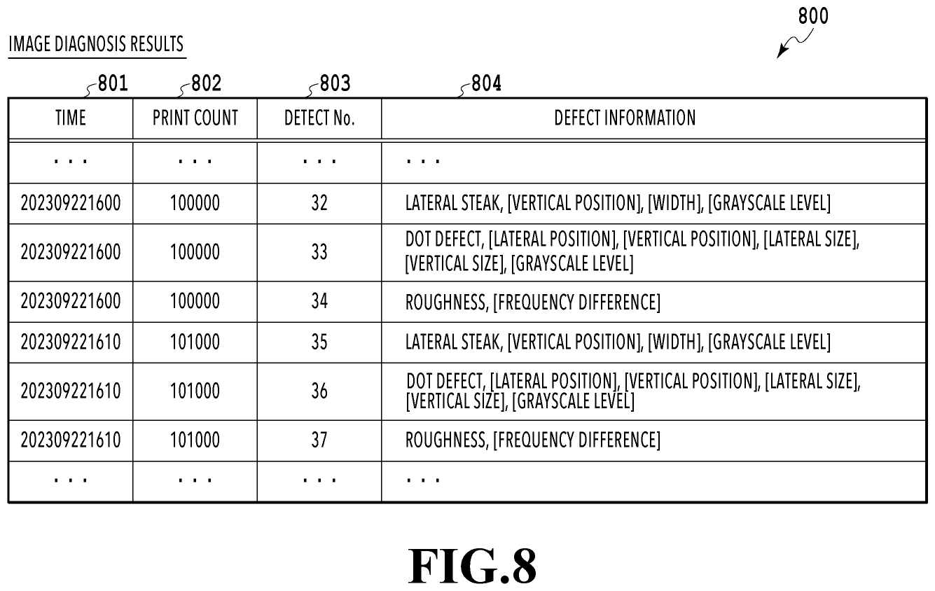

FIG. 8 is a diagram presenting an example of image diagnosis results. Since no vertical streak is determined in the example in FIG. 7, there is no record of a vertical streak in FIG. 8. In the image diagnosis results, information of items including a time 801, a print count 802, a defect No. (defect number) 803, and defect information 804 is listed in a table format. The time 801 indicates a time when the image diagnosis was performed. The print count 802 indicates the counted number of times that printing has been performed. The defect No. (defect number) 803 indicates an identification number for identifying a determined defect. The defect information 804 indicates detailed data on the determined defect.

In S1510, the image difference diagnosis unit 1105 determines whether or not the iteration is already executed on all the vertical streak candidates. The process is returned to S1507 in a case where it is determined that the iteration is not executed yet on any of the vertical streak candidates. The iteration of S1507 to S1510 is ended in a case where it is determined that the iteration is already executed on all the vertical streak candidates.

Subsequently, in steps S1511 to S1515, a determination about a lateral streak (lateral streak defect) is made. The specific processes are the same as the above processes for the vertical streak in S1506 to S1510 only except for the direction.

In S1511, the image difference diagnosis unit 1105 extracts lateral streak candidates. A portion at which the value of the lateral average profile increases or decreases from the average value of the lateral average profile by a previously-specified threshold or more is determined as a lateral streak candidate.

In S1512, the image difference diagnosis unit 1105 starts an iteration process on each of lateral streak candidates. In the case of the example in FIG. 7, there are two lateral streak candidates at vertical positions 708 and 709 and accordingly the iteration process is executed twice.

In S1513, the image difference diagnosis unit 1105 determines whether or not the lateral streak candidate is a lateral streak. The determination method includes checking the lateral average profile at the vertical position of the lateral streak candidate, and determining the lateral streak candidate as a lateral streak in a case where the variance of the pixel values is equal to or more than a previously-specified threshold. In the case of the example in FIG. 7, the lateral average profile at the vertical position 708 of the lateral streak candidate is of a profile along a broken line 710 of the difference image 701. In addition, the lateral average profile at the vertical position 709 of the lateral streak candidate is of a profile along a broken line 711 of the difference image 701. Since the variance value of the profile along the broken line 710 exceeds a previously-specified threshold of 1, it is determined that the lateral streak candidate is a lateral streak. Meanwhile, since the variance value of the profile along the broken line 711 is equal to or less than the previously-specified threshold of 1, it is determined that the lateral streak candidate is not a lateral streak. The process proceeds to S1515 in a case where it is determined that the lateral streak candidate is not a lateral streak (NO in S1513). The process proceeds to S1514 in a case where it is determined that the lateral streak candidate is a lateral streak (YES in S1513).

The image difference diagnosis unit 1105 performs a process in S1514 in a case where it is determined in S1513 that the lateral streak candidate is a lateral streak. The image difference diagnosis unit 1105 determines the vertical position, the width, and the grayscale level of the lateral streak, thereby obtaining an image diagnosis result. Then, the obtained image diagnosis result is stored. In the present embodiment, all the units in the result are the same as in the description for S1509. Since one lateral streak is determined in the example in FIG. 7, one record for the lateral streak is added as a defect No. 35 in FIG. 8 presenting the example of the image diagnosis results.

In S1515, the image difference diagnosis unit 1105 determines whether or not the iteration is already executed on all the lateral streak candidates. The process is returned to S1512 in a case where it is determined that the iteration is not executed yet on any of the lateral streak candidates. The iteration of S1512 to S1515 is ended in a case where it is determined that the iteration is already executed on all the lateral streak candidates.

Subsequently, in steps S1516 to S1520, a determination about a dot defect (circular-spot defect) is made. First, in S1516, the image difference diagnosis unit 1105 extracts dot defect candidates. An area at intersection coordinates of a portion where both the vertical average profile and the lateral average profile increase or decrease by a previously-specified threshold or more is determined as a dot defect candidate. In the case of the example in FIG. 7, areas 712 and 713 on the difference image 701 are extracted as dot defect candidates. As in the case of the above streaks, in the case where successive areas in the lateral direction and the vertical direction are extracted as dot defect candidates, the successive areas are extracted as one dot defect candidate having certain lateral and vertical widths.

In S1517, the image difference diagnosis unit 1105 starts an iteration process on each of dot defect candidates. In the case of the example in FIG. 7, there are two areas 712 and 713 as the dot defect candidates and accordingly the iteration process is executed twice.

In S1518, the image difference diagnosis unit 1105 determines whether or not each dot defect candidate is a dot defect. The determination method includes checking the vertical and lateral average profiles of the dot defect candidate, and determining the dot defect candidate as a dot defect in a case where both of the variances of the pixel values in the vertical and lateral average profiles are equal to or more than a previously-specified threshold. In the case of the example in FIG. 7, since the variance in the lateral average profile of the dot defect candidate 712 is less than a previously-specified threshold of 1, it is determined that the dot defect candidate 712 is not a dot defect. Meanwhile, since both of the variances in the vertical and lateral average profiles of the dot defect candidate 713 exceed the previously-specified threshold of 1, it is determined that the dot defect candidate 713 is a dot defect. The process proceeds to S1520 in a case where it is determined that the dot defect candidate is not a dot defect (NO in S1518). On the other hand, the process proceeds to S1519 in a case where it is determined that the dot defect candidate is a dot defect (YES in S1518).

The image difference diagnosis unit 1105 performs a process in S1519 in a case where it is determined in S1518 that the dot defect candidate is a dot defect. The image difference diagnosis unit 1105 determines the lateral position, the vertical position, the lateral size, the vertical size, and the grayscale level of the dot defect, thereby obtaining an image diagnosis result. Then, the obtained image diagnosis result is stored. In the present embodiment, all the units in the result are the same as in the description for S1509. Since one dot defect is determined in the example in FIG. 7, one record for the dot defect is added as a defect No. 36 in FIG. 8 presenting the example of the image diagnosis results.

In S1520, the image difference diagnosis unit 1105 determines whether or not the iteration is already executed on all the dot defect candidates. The process is returned to S1517 in a case where it is determined that the iteration is not executed yet on any of the dot defect candidates. The iteration of S1517 to S1520 is ended in a case where it is determined that the iteration is already executed on all the dot defect candidates.

Subsequently, in steps S1521 to S1524, a determination about roughness is made. First, in S1521, the image difference diagnosis unit 1105 converts both the chart image and the scanned image to representations in the frequency domain. Specifically, the image difference diagnosis unit 1105 performs two-dimensional FFT transformation on the chart image and the scanned image, and further integrates the power spectra at each frequency, thereby converting each of them into one-dimensional frequency information (RAPS information).

In S1522, the image difference diagnosis unit 1105 calculates a frequency difference between the chart image and the scanned image. Specifically, the image difference diagnosis unit 1105 obtains a RAPS difference value between the RAPS information of the chart image and the RAPS information of the scanned image.

In S1523, the image difference diagnosis unit 1105 determines whether or not roughness is found. The determination method includes calculating a roughness determination value by integrating frequency information obtained by multiplying the RAPS difference value by a visual characteristic (VTF: visual transfer function. In the case where this roughness determination value exceeds a previously-specified threshold, it is determined that roughness is found. The processes in the sequence presented in FIG. 5 are ended in a case where it is determined that no roughness is found (NO in S1523). On the other hand, the process proceeds to S1524 in a case where it is determined that roughness is found (YES in S1523).

The image difference diagnosis unit 1105 performs a process in S1524 in a case where it is determined in S1523 that roughness is found. The image difference diagnosis unit 1105 determines the frequency difference value, that is, the RAPS difference value of the roughness, thereby obtaining an image diagnosis result. Then, the obtained image diagnosis result is stored. In the present embodiment, one record for the roughness is added as a defect No. 37 in FIG. 8 presenting the example of the image diagnosis results.

Here, the description of the detailed sequence in S15 is ended.

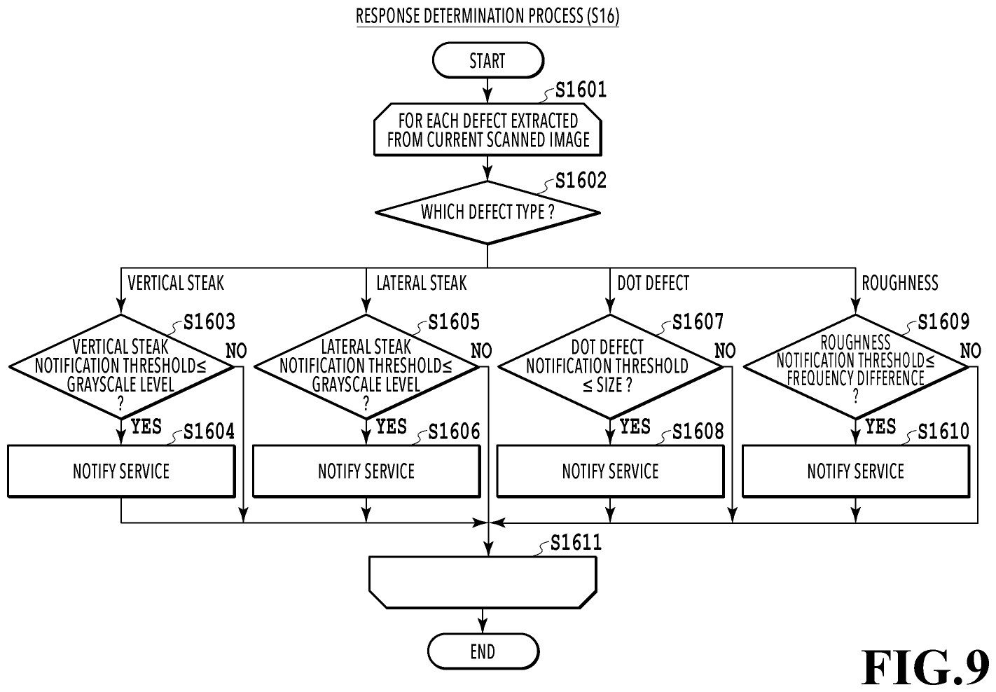

The description returns to FIG. 3. In S16, the image difference diagnosis unit 1105 determines a response based on the diagnosis result. In the present embodiment, in the case where a defect extracted from the current scanned image exceeds a previously-specified threshold, a notification to a service is made as a response. The response determination process will be described in detail by using FIG. 9. The service may be, for example, a base that provides services such as maintenance and inspection of a target apparatus or a serviceman at the base.

### (Response Determination Process)

FIG. 9 is a flowchart presenting a detailed sequence of the response determination process (S16).

In S1601, the image difference diagnosis unit 1105 starts an iteration for each of defects extracted from a current scanned image. The defect information is identified in reference to the image diagnosis results.

In S1602, the image difference diagnosis unit 1105 determines a type of a defect in reference to the defect information stored in the image diagnosis results. In a case where the type of the defect is determined as a vertical streak, the process proceeds to S1603. In a case where the type of the defect is determined as a lateral streak, the process proceeds to S1605. In a case where the type of the defect is determined as a dot defect, the process proceeds to S1607. In a case where the type of the defect is determined as roughness, the process proceeds to S1609.

In S1603, the image difference diagnosis unit 1105 determines whether or not the grayscale level of the vertical streak is equal to or more than a preset vertical streak notification threshold. In a case where it is determined that the grayscale level of the vertical streak is less than the preset vertical streak notification threshold (NO in S1603), the process proceeds to S1611. In a case where it is determined that the grayscale level of the vertical streak is equal to or more than the preset vertical streak notification threshold (YES in S1603), the process proceeds to S1604.

In S1604, the image difference diagnosis unit 1105 notifies the service that the vertical streak occurs in the image forming apparatus 140.

In S1605, the image difference diagnosis unit 1105 determines whether or not the grayscale level of the lateral streak is equal to or more than a preset lateral streak notification threshold. In a case where it is determined that the grayscale level of the lateral streak is less than the preset lateral streak notification threshold (NO in S1605), the process proceeds to S1611. In a case where it is determined that the grayscale level of the lateral streak is equal to or more than the preset lateral streak notification threshold (YES in S1605), the process proceeds to S1606.

In S1606, the image difference diagnosis unit 1105 notifies the service that the lateral streak occurs in the image forming apparatus 140.

In S1607, the image difference diagnosis unit 1105 determines whether or not any of the lateral size and the vertical size of the dot defect is equal to or more than a preset dot defect notification threshold. In a case where it is determined that both of the lateral size and the vertical size of the dot defect are less than the preset dot defect notification threshold (NO in S1607), the process proceeds to S1611. In a case where it is determined that any of the lateral size and the vertical size of the dot defect is equal to or more than the preset dot defect notification threshold (YES in S1607), the process proceeds to S1608.

In S1608, the image difference diagnosis unit 1105 notifies the service that the dot defect occurs in the image forming apparatus 140.

In S1609, the image difference diagnosis unit 1105 determines whether or not the frequency difference of the roughness is equal to or more than a preset roughness notification threshold. In a case where it is determined that the frequency difference of the roughness is less than the preset roughness notification threshold (NO in S1609), the process proceeds to S1611. In a case where it is determined that the frequency difference of the roughness is equal to or more than the preset roughness notification threshold (YES in S1609), the process proceeds to S1610.

In S1610, the image difference diagnosis unit 1105 notifies the service that the roughness occurs in the image forming apparatus 140.

In S1611, the image difference diagnosis unit 1105 determines whether or not the process is completed on all the defects extracted from the current scanned image. In a case where it is determined that the process is not completed on all the defects extracted from the current scanned image, the process is returned to S1601 and the process in S1602 and the subsequent steps is performed on the defect yet to be subjected to the process among the defects extracted from the current scanned image. On the other hand, in a case where it is determined that the process is completed on all the defects extracted from the current scanned image, the sequence presented in FIG. 9 is ended.

Here, the description of the detailed sequence in S16 is ended.

In sum, in S16, regarding each of the defects extracted from the current scanned image, the service is notified of the type of the determined defect (for example, a vertical streak, a lateral streak, a dot defect, and roughness).

Here, the description of the entire sequence is ended.

### Effect of Embodiment 1

As described above, according to the present embodiment, the user is prevented from mistakenly identifying an identification pattern by visually recognizing an image defect that would not occur under the normal output conditions. This reduces the occurrence of downtime associated with the adjustment and other work.

### (Results of Interest Level Analysis)

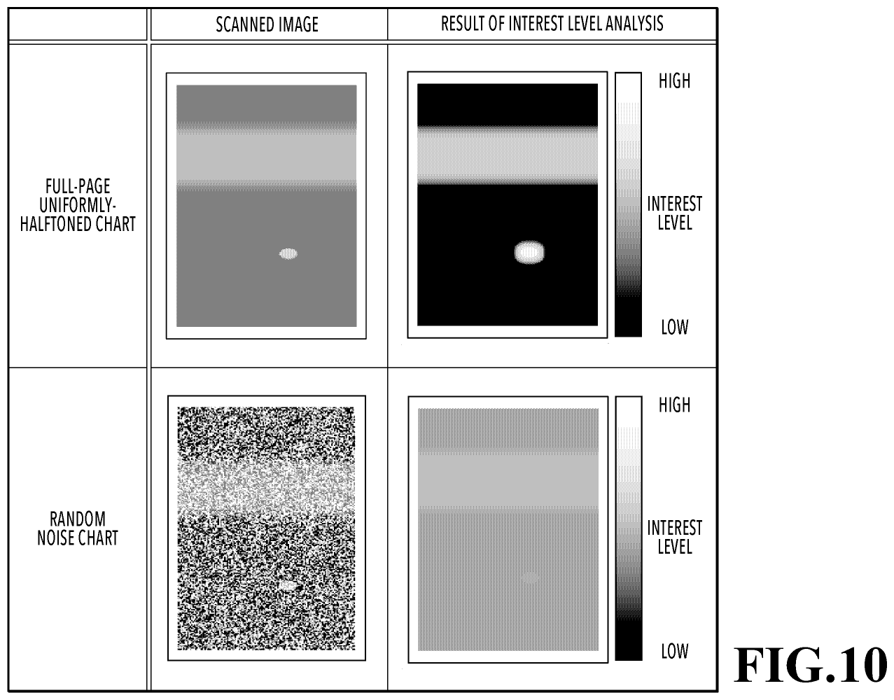

FIG. 10 is a diagram presenting an example of results of interest level analysis according to the present embodiment. In FIG. 10, an upper side presents a case of a full-page uniformly-halftoned chart, which is generally used to determine a defect, for comparison, and a lower side presents a case of a random noise chart created in the present embodiment. In FIG. 10, a left side presents scanned images of the respective charts printed by an image forming apparatus which may produce defective images, and a right side presents the results of interest level analysis on the scanned images.

The results of the interest level analysis herein are schematic views of saliency maps (also called salience maps) created using a saliency map calculation method. Although various algorithms have been proposed for calculating saliency maps, they basically utilize the human's characteristic of paying attention depending on the spatial or temporal arrangement of sensory stimuli. An area with a large difference in luminance from its neighborhood or an area with a different shape from its neighborhood is calculated as a highly-interest area.

As presented in FIG. 10 as the results of the interest level analysis, in the conventionally-used full-page uniformly-halftoned chart, defective portions have high interest levels. In comparison, in the random noise chart, the defective portions have relatively low interest levels because the interest level of the random noise image increases. As is often discussed concerning the S/N ratio, this indicates that a signal (here, the luminance of each of the defective portions) is buried in large noise (here, the random noise chart has large noise across the entire frequency band), and therefore is made difficult to perceive. This prevents misidentification by the user.

Although the random noise chart is created in the present embodiment, the chart only has to contain random noise. For example, a chart in which random noise is overlaid on a natural image may be created.

In the above description, in S12, the 8-bit grayscale image with 150 dpi is created as the random noise chart, but the random noise chart is not limited to this image. A random noise chart only has to be such that randomly occurring noise can be observed in frequency analysis. In addition, a random noise chart may be different in the resolution or the number of bits or may be a color image. In the case of a color image, a random noise chart may be created in a method such as creating random charts of the respective colors and then and synthesizing them. Instead, a random noise chart may be created in a method of creating an image by applying noise in a frequency space.

In the above description, the electrophotographic printer is used in S13, but the image forming apparatus is not limited to this. The image forming apparatus may be any apparatus into which the image diagnosis method can be introduced, including an inkjet printer, an offset printing machine, a gravure printing machine, and so on.

In the above description, the scanned image is read in S14 in the image capturing method using the scanner apparatus which operates together with the image forming apparatus, but the image capturing method is not limited to this. The image capturing method only has to be capable of capturing an image of a printed product of an image printed, and may be, for example, a method using a scanner apparatus independent of the image forming apparatus, or a camera.

In the above description, the image difference diagnosis process is executed in S15. The difference diagnosis method is not particularly limited and may be any method utilizing a difference between the chart image and the scanned image.

In the above, the example in which the service is notified based on the diagnosis result in S16 is described, but the response based on the diagnosis result is not limited to this. For example, automatic recovery or automatic parts delivery may be performed based on the diagnosis result, or an additional diagnosis may be performed to further identify the cause of the defect. Instead, it is also possible to take no response based on the diagnosis result.

### Second Embodiment

In the present embodiment, description will be given of an image diagnosis method using a defect imitation chart image (imitation image). In the present embodiment, different points from those in the image processing system in Embodiment 1 will be mainly described.

### (Functional Configuration of Image Processing System)

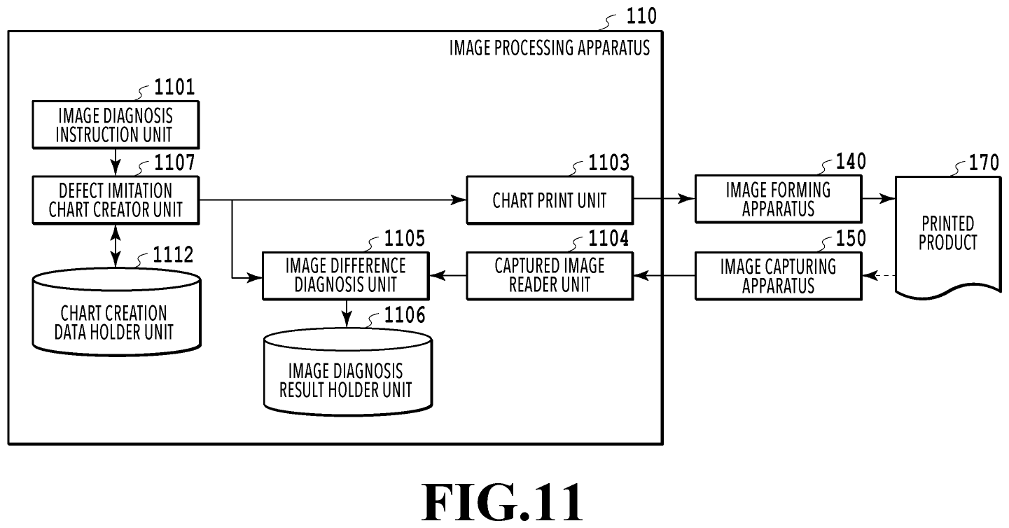

FIG. 11 is a diagram illustrating a configuration example of the image processing system in the present embodiment. The image processing system in the present embodiment includes a defect imitation chart creator unit 1107 and a chart creation data holder unit 1112 in place of the random noise chart creator unit 1102 and the chart creation data holder unit 1111 included in the image processing system in Embodiment 1.

In response to an instruction to perform an image diagnosis, the defect imitation chart creator unit (hereinafter referred to as the second chart creator unit) 1107 creates a defect imitation chart for image diagnosis. The defect imitation chart for image diagnosis will be described later in detail.

The chart creation data holder unit 1112 holds data for chart creation such, for example, as chart parameters to be used in the second chart creator unit 1107.

### (Processes to be Executed by Image Processing System)

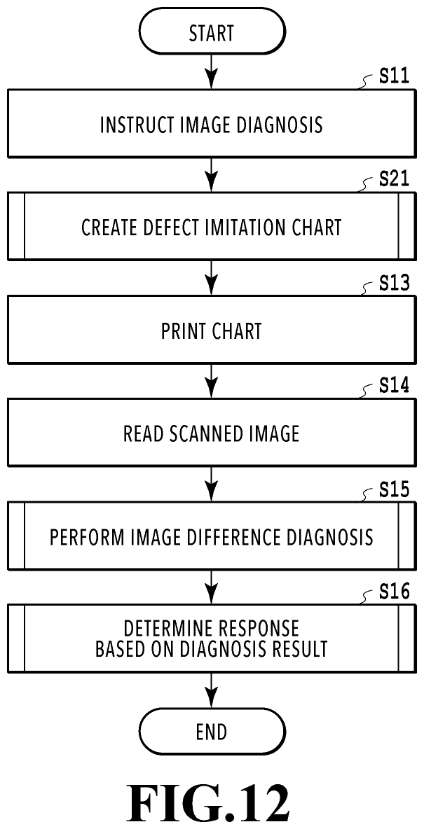

FIG. 12 is a flowchart presenting a sequence of processes to be executed by the image processing system in the present embodiment. In the present embodiment, a process in S21 to create a defect imitation chart is executed in place of the process in S12 to create a random noise chart in Embodiment 1.

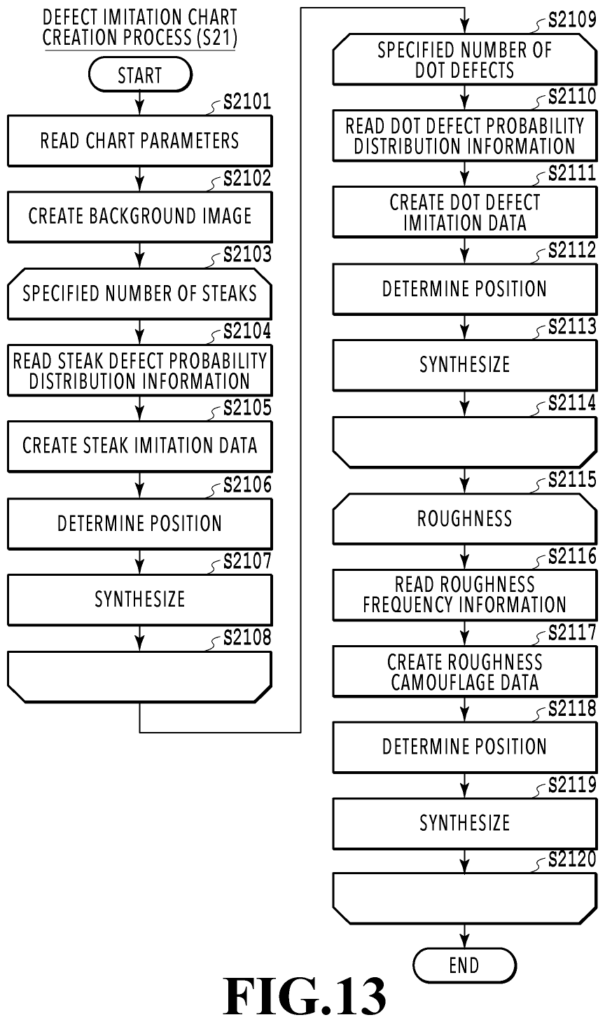

In S21, the second chart creator unit 1107 creates a defect imitation chart. The defect imitation chart creation process will be described in detail by using FIG. 13.

### (Defect Imitation Chart Creation Process)

FIG. 13 is a flowchart presenting a detailed sequence of the defect imitation chart creation process (S21).

In S2101, the second chart creator unit 1107 reads the chart parameters held in advance in the chart creation data holder unit 1112. The chart parameters include a size, a resolution, color information, a specified number of streaks, a specified number of dot defects, and a specified number of roughness for a chart image. In the present embodiment, the image size is A3 sheet size, the resolution is 150 dpi, and the image format is 8-bit grayscale. In addition, the specified number of streaks is 4, the specified number of dot defects is 30, and the specified number of roughness is 1.

In S2102, the second chart creator unit 1107 creates a background image. The background image is created based on the above chart parameters. In all the pixels in the drawing range of the background image, 128 (50% gray) is stored. In the pixels outside the drawing range, 255 (white) is stored. In the present embodiment, an area inside a 10 mm-margin of the sheet size, which is a printable area of the image forming apparatus 140, is set as the drawing range.

In steps S2103 to S2108, streak imitation data is added to the background image. First, in S2103, the second chart creator unit 1107 starts an iteration process the same number of times as the specified number of streaks.

In S2104, the second chart creator unit 1107 reads streak defect probability distribution information held in advance in the chart creation data holder unit 1112. The streak defect probability distribution information is information in which streaks that occur in the image forming apparatus 140 are divided into classes according to information on the vertical and lateral directions, the grayscale level, and the width, and the occurrence frequencies of the respective classes of the streaks are expressed as a probability density distribution.

### (Streak Defect Probability Distribution Information)

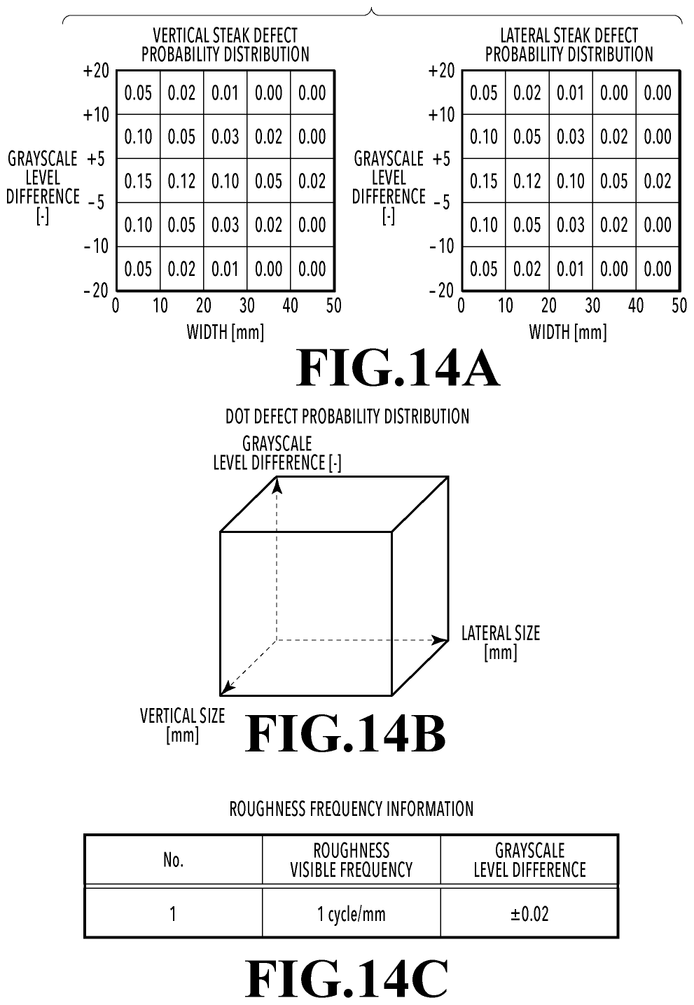

FIGS. 14A to 14C are diagrams illustrating examples of defect probability distribution information. FIG. 14A presents an example of the streak defect probability distribution information. The streak defect probability distribution information in the present embodiment is information including two defect probability distributions of vertical streaks and lateral streaks, each defect probability distribution being information with axes representing a grayscale level difference from an average value and a width of a steak. The unit of the grayscale level difference is a pixel value and the unit of the width is [mm].

In S2105, the second chart creator unit 1107 creates streak imitation data. The streak imitation data is two-dimensional data for drawing a single streak. The streak imitation data has the same resolution as the background image and is in a data format in which data including a minus value can be written.

### (Streak Imitation Data Creation Method)

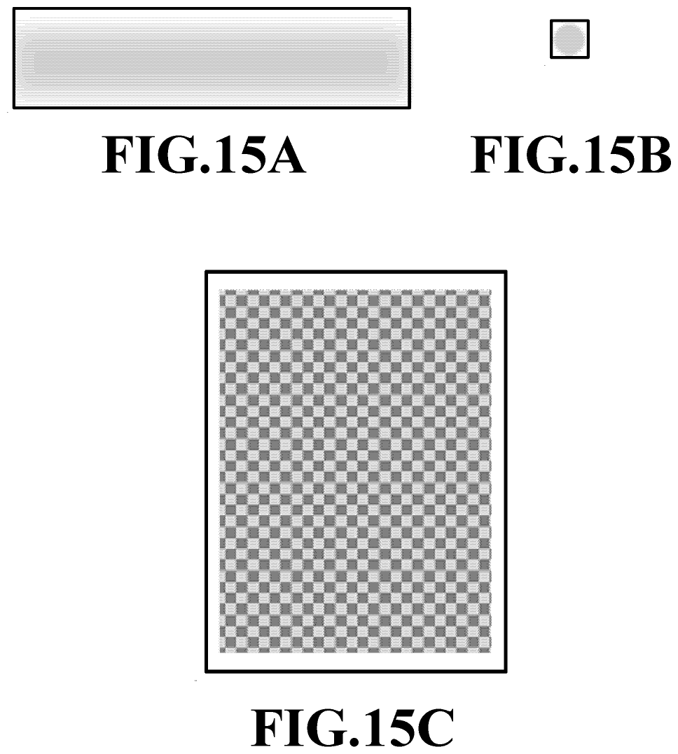

First, using a random number for outputting a binary value, the second chart creator unit 1107 determines whether streak imitation data to be created is of a vertical streak or a lateral streak. For example, a lateral streak is assumed to be selected. Next, the second chart creator unit 1107 selects the lateral streak defect probability distribution information from the streak defect probability distribution information read in S2104. Subsequently, the second chart creator unit 1107 randomly selects one data piece by using the selected lateral streak defect probability distribution information. In the present embodiment, by way of example, the selected data piece is of a lateral streak having a grayscale level difference of −5 to −10 and a width of 10 [mm] to 20 [mm]. The second chart creator unit 1107 creates the streak imitation data based on the selected information. The streak imitation data has the same lateral size as the lateral size of the printable area of the background image and a vertical size equivalent to 25 [mm], which is the median 15 [mm] of the selected width plus upper and lower margins 5 [mm], and all stores 0. A region having a vertical size 15 [mm] and the same lateral size as the lateral size of the streak imitation data is selected at a center portion in the streak imitation data. In the data of the selected region, data of −8 is stored which is obtained by rounding up the median of the selected grayscale level difference. Further, a process of burring an edge portion is performed. Thus, the streak imitation data is created. FIG. 15A presents an example of the streak imitation data.

In S2106, the second chart creator unit 1107 determines a position at which the streak imitation data created in S2105 will be synthesized in the background image. The second chart creator unit 1107 also determines the position by using a random number. For the random number in the case of the lateral streak, a random number generator is used which outputs a random number from a range equal to the number of data pieces in the printable area in the vertical direction.

In S2107, the second chart creator unit 1107 synthesizes the streak imitation data into the background image. The synthesizing method includes adding the streak imitation data to the position determined in S2106 in the background image. In the case where the data obtained by the addition falls below or exceeds the data range of 0 to 255 of the background image, the data is clipped to the lower or upper limit value.

In S2108, the second chart creator unit 1107 determines whether or not the iteration is already executed the same number of times as the specified number of streaks. The process is returned to S2103 in a case where it is determined that the iteration is not executed yet. The iteration of the processes in S2103 to S2108 is ended in a case where it is determined that the iteration is already executed.

Next, in steps S2109 to S2114, dot defect imitation data is added to the background image. First, in S2109, the second chart creator unit 1107 starts an iteration process the same number of times as the specified number of dot defects.

In S2110, the second chart creator unit 1107 reads dot defect probability distribution information held in advance in the chart creation data holder unit 1112. The dot defect probability distribution information is information in which dot defects that may occur in the image forming apparatus 140 are divided into classes according to information on the vertical size, the lateral size, and the grayscale level, and the occurrence frequencies of the respective classes of the dot defects are expressed as a probability density distribution. FIG. 14B presents an example of the dot defect probability distribution information. In FIG. 14B, the numeric values in the probability distribution inside the axes are omitted from the illustration. The unit of the grayscale level difference is a pixel value and the unit of each size is [mm].

In S2111, the second chart creator unit 1107 creates dot defect imitation data. The dot defect imitation data is two-dimensional data for drawing a single dot defect. As in the streak imitation data, the dot defect imitation data also has the same resolution as the background image and is in a data format in which data including a minus value can be written. As in the streak imitation data, the creation method includes randomly selecting one data piece by using the dot defect probability distribution information. In the present embodiment, by way of example, the selected data piece is of a dot defect having a vertical size of 0.5 [mm], a lateral size of 0.5 [mm], and a grayscale level difference of −5. The dot defect imitation data is created based on the selected information. The dot defect imitation data has a vertical size equal to the vertical size of the selected dot defect and a lateral size equal to the lateral size of the selected dot defect, and all stores 0. A circular region having a vertical size of 0.5 [mm] and a lateral size of 0.5 [mm] is selected at a center portion in the dot defect imitation data, and the selected grayscale level value of −5 is stored in the data in the selected region. Thus, the dot defect imitation data is created. FIG. 15B presents an example of the dot defect imitation data.

In S2112, the second chart creator unit 1107 determines a position at which the dot defect imitation data created in S2111 will be synthesized in the background image. The second chart creator unit 1107 determines each of the vertical position and the lateral position by using a random number. For the random numbers, a random number generator is used which outputs a random number from a range equal to the number of data pieces in the printable area in the each of the vertical and lateral directions.

In S2113, the second chart creator unit 1107 synthesizes the dot defect imitation data into the background image. The synthesizing method includes adding the dot defect imitation data to the position determined in S2112 in the background image. In the case where the data obtained by the addition falls below or exceeds the data range of 0 to 255 of the background image, the data is clipped to the lower or upper limit value.

In S2114, the second chart creator unit 1107 determines whether or not the iteration is already executed the same number of times as the specified number of dot defects. The process is returned to S2109 in a case where it is determined that the iteration is not executed yet. The iteration of the processes in S2109 to S2114 is ended in a case where it is determined that the iteration is already executed.

Next, in steps S2115 to S2120, roughness camouflage data is added to the background image. First, in S2115, the second chart creator unit 1107 starts an iteration process the same number of times as the specified number of roughness.

In S2116, the second chart creator unit 1107 reads roughness frequency information held in advance in the chart creation data holder unit 1112. The roughness frequency information is information which stores a frequency at which roughness is easily visible. The frequency information at which roughness is easily visible can be obtained by using the visual perception frequency characteristic (VTF: visual transfer function), which varies with a viewing distance. FIG. 14C presents an example of the roughness frequency information. In the present embodiment, the viewing distance from a printed product is set to 300 mm and a peak value of VTF at that distance of 1 cycle/mm is stored. In addition, the grayscale level difference has to be set to be equal to or greater than a grayscale level difference visible to the human eye. In the present embodiment, a grayscale level difference of ±0.02 is set assuming an apparatus type with a visible grayscale level difference of 2% or greater. The same number of pieces of the roughness frequency information as the specified number of roughness is stored.

In S2117, the second chart creator unit 1107 creates roughness camouflage data. The roughness camouflage data is two-dimensional data of a chart with high-frequency patterns drawn over the entire page. As in the streak imitation data, the roughness camouflage data also has the same resolution as the background image and is in a data format in which data including a minus value can be written. The creation method includes selecting a data piece corresponding to the iteration count from the roughness frequency information. In the present embodiment, by way of example, a roughness visible frequency of 1 cycle/mm and a grayscale level difference of +0.02 stored in information No. 1 is selected from the roughness frequency information in FIG. 14C. The roughness camouflage data is created based on the selected information. First, a checker pattern in one cycle having the same cycle as the size of the roughness visible frequency is created. In the present embodiment, four 1 mm squares are arranged side by side, with the upper left and lower right squares having a first grayscale level difference, and the upper right and lower left squares having a second grayscale level difference. Then, −0.02 is stored as the first grayscale level difference and +0.02 is stored as the second grayscale level difference. The checker patterns per cycle are laid out in a tile-like manner across the entire page of a sheet. Thus, the roughness camouflage data is created. FIG. 15C presents an example of the roughness camouflage data.

In S2118, the second chart creator unit 1107 determines a position at which the roughness camouflage data created in S2117 will be synthesized in the background image.

In S2119, the second chart creator unit 1107 synthesizes the roughness camouflage data created in S2117 into the background image. The synthesizing method includes adding the roughness camouflage data to the position determined in S2118 in the background image. In the case where the data obtained by the addition falls below or exceeds the data range of 0 to 255 of the background image, the data is clipped to the lower or upper limit value.

In S2120, the second chart creator unit 1107 determines whether or not the iteration is already executed the same number of times as the specified number of roughness. The process is returned to S2115 in a case where it is determined that the iteration is not executed yet. The iteration of the processes in S2115 to S2120 is ended in a case where it is determined that the iteration is already executed.

Here, the description of the detailed sequence in S21 is ended.

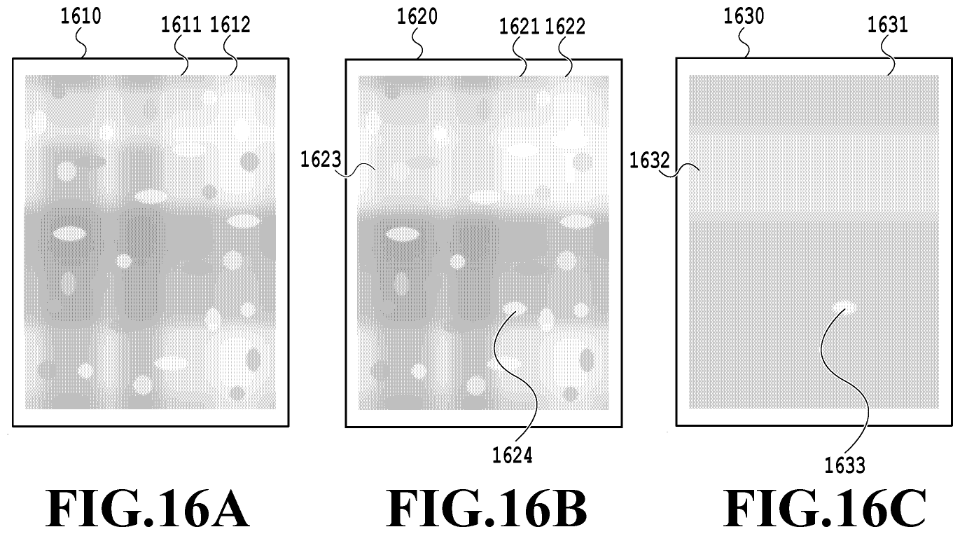

The other steps are the same as in Embodiment 1 and therefore the description thereof is omitted herein. As the examples of the images used in the present embodiment, FIG. 16A presents a chart image, FIG. 16B presents a scanned image, and FIG. 16C presents a difference image. A chart image 1610 contains a chart image 1611 in which an identification pattern for identifying defects in the image forming apparatus 140 is formed. The chart image 1610 further contains a defect imitation chart (defect camouflage chart) 1612, which is a visibility reducing pattern image for making the above identification pattern less visible. A scanned image 1620 contains a chart image 1621 in which identification patterns 1623 and 1624 for identifying defects in the image forming apparatus 140 are formed. The scanned image 1620 further contains a defect imitation chart (defect camouflage chart) 1622, which is a visibility reducing pattern image for making the above identification patterns 1623 and 1624 less visible. A difference image 1630 contains a chart image 1631 in which identification patterns 1632 and 1633 for identifying the defects in the image forming apparatus 140 are formed.

Here, the description of the entire sequence is ended.

### Effect of Embodiment 2

As described above, according to the present embodiment, user's misidentification of identification patterns is more effectively reduced than in the case using the random noise pattern. This reduces the occurrence of downtime associated with adjustment and other work, which is actually unneeded.

### (Results of Interest Level Analysis)

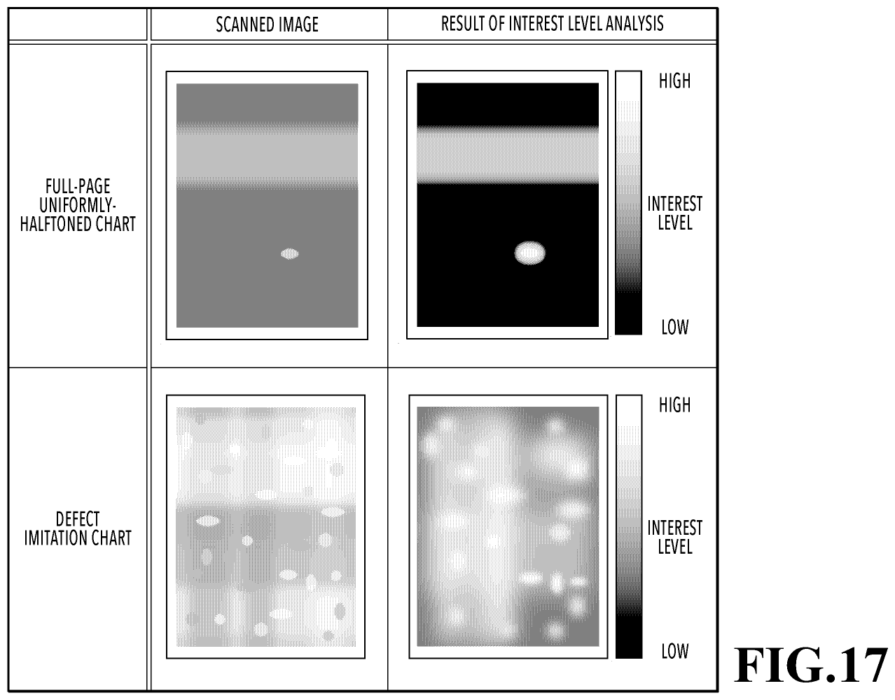

FIG. 17 is a diagram presenting an example of the results of interest level analysis according to the present embodiment. In FIG. 17, an upper side presents a case of a full-page uniformly-halftoned chart, which is generally used to determine a defect, for comparison, and a lower side presents a case of a defect imitation chart created in the present embodiment, as in the case of FIG. 10. In FIG. 17, a left side presents scanned images of the respective charts printed by an image forming apparatus which may produce defective images, and a right side presents the results of interest level analysis on the scanned images.

As presented in FIG. 17 as the results of the interest level analysis, in the defect imitation chart, the interest levels of the defect imitation images increase, as compared with the conventionally-used full-page uniformly-halftoned chart. As a result, the user's attention does not concentrate on only defective portions that occurred in the image forming apparatus, which makes it difficult for the user to recognize the defective portions. This prevents misidentification by the user.

In the above description, in S21, the defect imitation chart is created from the defect probability density distribution prepared in advance, but the creation method is not limited to this and may be any method capable of creating a defect imitation. For example, a defect imitation chart may be created in a creation method using fixed streak imitation data and fixed dot defect imitation data without using the defect probability density distributions. Instead, a defect imitation chart may be a chart image created by using a machine learning method with an evaluation function specified such that a scanned image in which defects by the image forming apparatus are overlaid on a chart image may have a small difference in saliency (salience).

In the above description, in S21, the 8-bit grayscale image with 150 dpi is created as the defect imitation chart, but the defect imitation chart is not limited to this. A defect imitation chart may be different in the number of bits or may be a color image. In the case of a color image, a defect imitation chart may be created in a method such as creating random charts of the respective colors and then and synthesizing them.

In the above description, in S21, the imitated defects are limited to the streaks and the dot defect but are not limited to these. Any defective patterns that may occur in the image forming apparatus may be imitated. For example, it is possible to imitate features such as discharge marks, variations in dot size and shape, variations in line edges, and color shifts.

In the above description, in S21, the number of defects is specified, but this is a non-limiting example. It is only necessary to arrange at least one defect.

### Third Embodiment

In the present embodiment, description will be given of a mode in which a message notifying a user that this is a chart image for image diagnosis is overlaid on the chart image for image diagnosis. In the present embodiment, different points from those in the image processing system in Embodiment 1 will be mainly described.

### (Functional Configuration of Image Processing System)

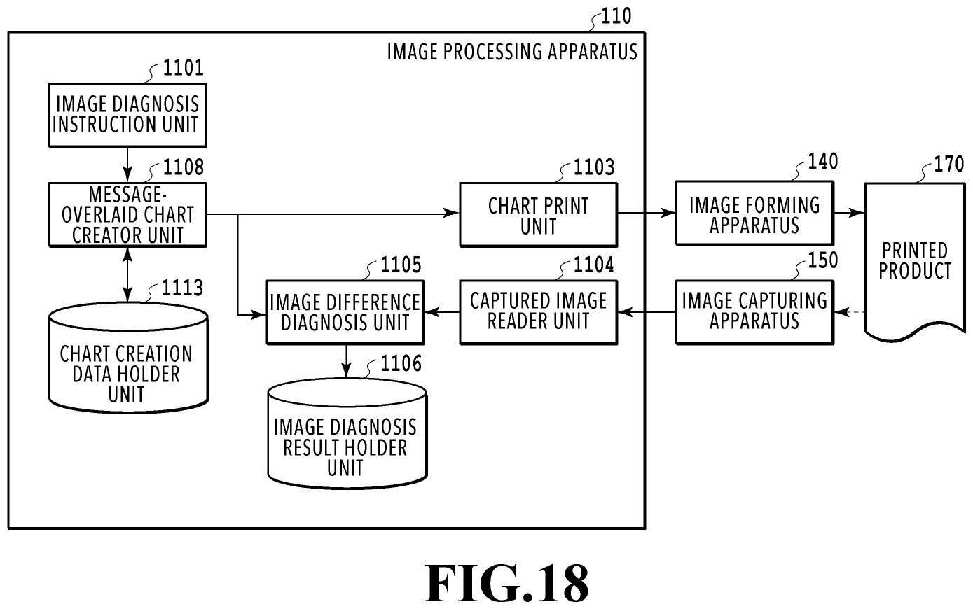

FIG. 18 is a diagram illustrating a configuration example of an image processing system in the present embodiment. The image processing system in the present embodiment includes a message-overlaid chart creator unit 1108 and a chart creation data holder unit 1113 in place of the random noise chart creator unit 1102 and the chart creation data holder unit 1111 included in the image processing system in Embodiment 1.

In response to an instruction to perform an image diagnosis, the message-overlaid chart creator unit (hereinafter referred to as the third chart creator unit) 1108 creates a message-overlaid chart image for image diagnosis. The message-overlaid chart image for image diagnosis will be described later in detail.

The chart creation data holder unit 1113 holds data for chart creation such, for example, as chart parameters to be used in the third chart creator unit 1108.

### (Processes to be Executed by Image Processing System)

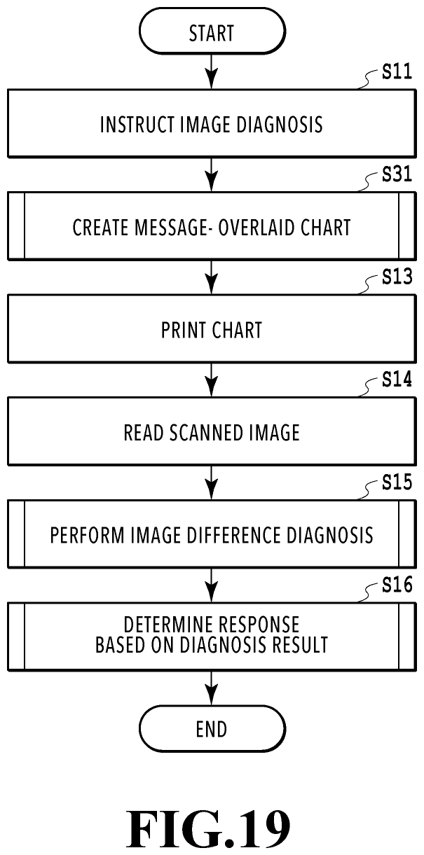

FIG. 19 is a flowchart presenting a sequence of processes to be executed by the image processing system in the present embodiment. In the present embodiment, a process in S31 to create a message-overlaid chart is executed in place of the process in S12 to create a random noise chart in Embodiment 1.

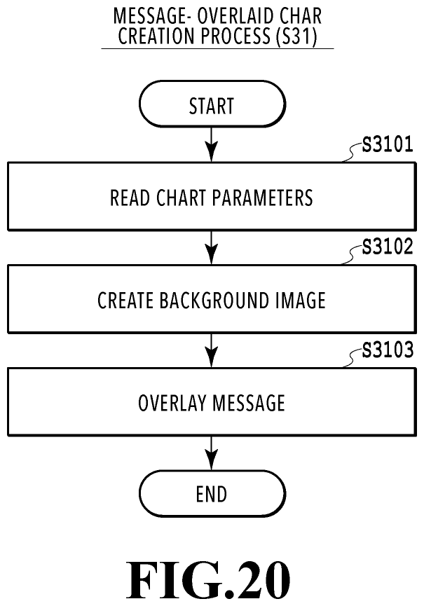

In S31, the third chart creator unit 1108 creates a message-overlaid chart. The message-overlaid chart image creation process will be described in detail by using FIG. 20.

### (Message-Overlaid Chart Image Creation Process)

FIG. 20 is a flowchart presenting a detailed sequence of the message-overlaid chart image creation process (S31).

In S3101, the third chart creator unit 1108 reads the chart parameters from the chart creation data holder unit 1113. The chart parameters include an image size, resolution, and color information. In the present embodiment, the image size is A3 sheet size, the resolution is 150 dpi, and the image format specifying the color information is 8-bit grayscale.

In S3102, the third chart creator unit 1108 creates a background image. The background image is a pattern image for identifying defects in the image forming apparatus, and created based on the above chart parameters. In the present embodiment, an image with the pixel values of 128 (50% gray) in the entire image area is created as the background image.

In S3103, the third chart creator unit 1108 overlays a message on the background image, the message indicating that the image is a print for image diagnosis, a print for identifying a defect in the apparatus, or a print made under conditions other than the normal conditions for printed products. The message is overlaid such that the user can visually perceive the message distinctively from the background image. In the present embodiment, the message is overlaid with a text size of 20 points and a message region having pixel values of 64 (75% gray). The overlaying position may be set on a lower side, a center side, or an upper side in the vertical direction.

### (Message-Overlaid Chart Image)

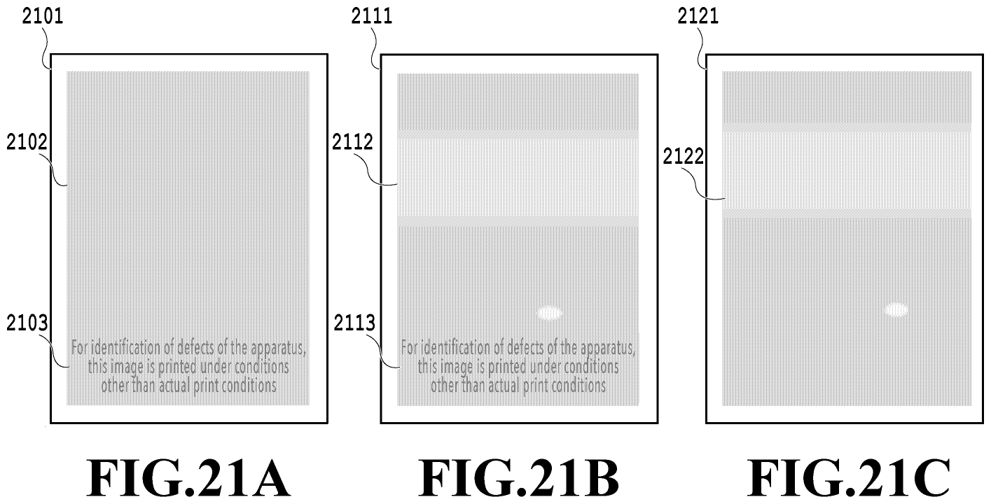

FIGS. 21A to 21C are views presenting examples of message-overlaid chart images. FIG. 21A presents an example of the message-overlaid chart image created in S31. FIG. 21B presents an example of a scanned image of a printed product of the message-overlaid chart image. FIG. 21C presents an example of a difference image between the chart image in FIG. 21A and the scanned image in FIG. 21B.

As presented in FIG. 21A, a background image 2102 is arranged inside a print image 2101 in the message-overlaid chart image. In addition, a message 2103 is overlaid on the background image 2102. The above message is not limited to the message 2103 presented in FIGS. 21A and 21B. The above message may be a message indicating that the image is a print for image diagnosis, a print for identifying a defect in the apparatus, or a print made under conditions other than the normal conditions set for printed products.

In the scanned image as presented in FIG. 21B, an image 2112 corresponding to the background image 2102 is arranged inside an image 2111 corresponding to the print image 2101. In addition, an image 2113 corresponding to the message 2103 is overlaid on the image 2112 corresponding to the background image 2102.

In the difference image as presented in FIG. 21C, a difference image 2122 between the background image 2102 and the image 2112 is arranged inside a difference image 2121 between the print image 2101 and the image 2111. Since the message 2103 and the image 2113 have no difference, an image corresponding to the message 2103 is not present in the difference image.

The other steps are the same as in Embodiment 1 and the description thereof is omitted herein. As the examples of the images used in the present embodiment, FIG. 21A presents the chart image, FIG. 21B presents the scanned image, and FIG. 21C presents the difference image.

Here, the description of the entire sequence is ended.

### Effect of Embodiment 3

As described above, according to the present embodiment, in viewing a printed chart for image diagnosis, the user can be prevented from mistakenly identifying that a defect occurs in the image forming apparatus 140.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, an identification pattern for identifying defects in a print unit can be made less visible in a chart image.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-032790, filed Mar. 5, 2024, which is hereby incorporated by reference wherein in its entirety.

What is claimed is:

1. An image forming apparatus comprising:
a print unit configured to perform printing; and
a control unit configured to cause the print unit to print a chart image in which an identification pattern for identifying a defect in the print unit is formed and a pattern image different from the identification pattern such that the pattern image is overlaid on the chart image.

2. The image forming apparatus according to claim 1, wherein the pattern image is an image provided with noise.

3. The image forming apparatus according to claim 1, wherein the pattern image is an image randomly provided with noise.

4. The image forming apparatus according to claim 1, wherein the pattern image contains one or more imitation images each imitating the identification pattern.

5. The image forming apparatus according to claim 4, wherein the identification pattern contains at least one of a streak defect, a dot defect, roughness, and a color shift.

6. The image forming apparatus according to claim 1, wherein the pattern image is an image not indicating a defect in the print unit.

7. The image forming apparatus according to claim 6, wherein the pattern image contains a message not indicating a defect in the print unit.

8. The image forming apparatus according to claim 7, wherein the message indicates that a print is for diagnosing a defect in the print unit, that a print is for identifying a defect in the print unit, or that a print is made under a condition other than a normal condition set for a printed product.

9. The image forming apparatus according to claim 1, wherein the control unit causes the print unit to perform the printing while a received print job is being executed or while no received print job is being executed.

10. The image forming apparatus according to claim 1, wherein the pattern image is changed as needed.

11. The image forming apparatus according to claim 1, wherein the pattern image is an image for making the identification pattern less visible.

12. An image forming method comprising:
performing printing in a print unit; and
causing the print unit to print a chart image in which an identification pattern for identifying a defect in the print unit is formed and a pattern image different from the identification pattern such that the pattern image is overlaid on the chart image.

13. A non-transitory computer readable storage medium storing a program for causing a computer to perform an image forming method comprising:
performing printing in a print unit; and
causing the print unit to print a chart image in which an identification pattern for identifying a defect in the print unit is formed and a pattern image different from the identification pattern such that the pattern image is overlaid on the chart image.
